(19) United States
(12) Patent Application Publication
(10) Pub. No.: US 2022/0245590 A1
(43) Pub. Date: Aug. 4, 2022

(54) METHOD AND SYSTEM FOR COLLABORATATIVE EDITING, VERSIONING, CONFLICT RESOLUTION, DEPLOYMENT, AND AUTOMATED EVALUATION OF BUSINESS PROCESSES

(71) Applicant: The Concinnity Company, Nashville, TN (US)

(72) Inventors: Matt Cook, Lexington, MA (US); Bethany Wynns, Nashville, TN (US)

(73) Assignee: The Concinnity Company, Nashville, TN (US)

(21) Appl. No.: 17/617,200

(22) PCT Filed: Jun. 5, 2020
(86) PCT No.: PCT/US20/36477

§ 371 Date: Dec. 7, 2021

Related U.S. Application Data
(60) Provisional application No. 62/858,868, filed on Jun. 7, 2019.

(51) Int. Cl. G06Q 10/10

(52) U.S. Cl. CPC G06Q 10/103

(57) ABSTRACT

A system and method to develop, modify, share and deploy workflows across different organizations and evaluate the effect of those processes while maintaining each organization's process stability, security and independence.

### CROSS REFERENCE TO RELATED APPLICATIONS

This application claims priority benefit of the filing date of U.S. Provisional Patent Application 62/858,868, filed Jun. 7, 2019, the content of which is incorporated herein by reference in its entirety.

### FIELD OF INVENTION

This invention generally relates to business process management systems and specifically the process of designing, modifying, sharing, executing and evaluating processes seamlessly among different organizations.

### BACKGROUND

Traditionally, when an organization does not have the required institutional knowledge to solve a business need, it would hire a management consultant or an accountant to come in and institute a new process to solve that need. Since organizations of all kinds face many similar challenges that can be largely handled following predefined processes (often called workflows), hiring an experienced outside person made sense. Unfortunately, as businesses have become increasingly complex, and as technology has evolved, those processes have become more explicit and often far more heavily detailed, tracked and automated than humans can manage.

To address this, tools to manage these processes called business process management systems (BPMs) have evolved. These systems often share many common features such as visual editing, role-based tasks, conditional execution and even process definition/modeling languages (BPML) that can be exported and shared between competing BPMs.

As they have grown, they have largely diverged into two categories. The first is the highly technical BPM. These systems are designed for extremely technical users to accomplish things like “assemble a car” or “handle hundreds of thousands of user emails.” These systems are virtually impossible for a lay user to understand and modify, and the processes are limited to the single use case of each organization utilizing them without much deviation from the predefined process. Large consortiums have gotten together to try to standardize these technologies such as the “Windows Workflow Foundation” and “Open Workflow Description Language,” but they remain too technical for the everyday user. FIGS. 1(a) and 1(b) illustrate an example workflow definition and workflow description language, respectively.

The second category of business process management system is geared towards lay users who traditionally kept lists and spreadsheets. These systems try to use the advanced features of the BPMs such as user reporting, time tracking and workflow visualization, but keep the interfaces simple enough for a lay user. These systems come as a blank box for a team to implement its processes. When the systems do have predefined processes they come in the form of fake predefined data and steps rather than relevant information from the user's organization. Examples of these may include Trello, Airtable and Wrike. FIG. 2 shows a started workflow from Airtable.com.

The drawback of all these systems is that they haven't solved the original challenge: standardizing processes in a method so that they can be used easily across organizations. A lay user should be able to select processes from a library, apply a customization process and start working without the need for an advanced degree, or having to fully customize each workflow to match their own organization.

At the same time, in the software development world many strides have been made in version management systems (VMS) specifically collaborative editing, modifications, and acceptance of programming changes. These systems have become quite widespread and public, and they heavily rely on modifying text files directly and comparing changes within a text file. While users can share their business processes this way, it has made sharing, modifying and merging changes of other people's business processes extremely problematic, often requiring technical users to modify xml or json data by hand to customize the processes rather than being able to just install them and make changes.

In practice, attempting to handle all the customizations from each organization quickly becomes impossible to manage anything by hand with speed and accuracy. For example, a very simple workflow with (M) tasks and (N) organizations, where each organization makes 1 customization, and with only a single round of updates pushed out to each organization, very often results in N distinct processes of M Complexity and N×M distinct reports constructs, each based on (N×M/2)³ possible tasks. As soon as a second or third round of changes occurs, the complexity becomes increasingly daunting as it exponentially grows by twice the number of revisions (O) for a total complexity of (N×M/2)^{2O+1}. Just tracking which companies were doing what becomes a disaster. FIG. 4 shows an example of the complexity when reporting a task completion of an organization in a multi-tenant work environment.

Accordingly, there is a need for a business process management system that can be used by non-technical users to quickly download processes from a central repository, easily customize those process, share those customizations and deploy those processes across different organizations, and evaluate the effect of those processes under certain circumstances, while maintaining each organization's process independence.

### SUMMARY OF THE INVENTION

Aspects of the present disclosure allow an organization subscribe to a business process from another source, customize it with ease, submit those customizations to the source process, receive updates from its source, as well as report on the results of that process in a way that is meaningful to each organization.

Over time, each organization can maintain and develop its own processes, while collaborating on the pieces of the process in which it would like to share its changes as well as report on the outputs of those processes independently.

### BRIEF DESCRIPTION OF THE DRAWINGS

The accompanying drawings, which are incorporated into and constitute a part of this specification, illustrate one or more example aspects of the present invention and, together with the detailed description, serve to explain their principles and implementations.

FIGS. 1(a) and 1(b) illustrate example workflow definitions;

FIG. 2 illustrates example workflow description language;

FIG. 3 illustrates a started workflow from Airtable.com;

FIG. 4 illustrates an example of the complexity when reporting a task completion of an organization in a multi-tenant work environment;

FIG. 5(a) illustrates an example processor library;

FIG. 5(b) illustrates another example process library;

FIG. 6 illustrates an example copying or merging meta-data of subscribing organizations;

FIG. 7 illustrates an example message generated to prompt a user to update an existing workflow upon detecting new versions of the workflow are available;

FIG. 8 illustrates a workflow developed, published, changed and republished to a community including multiple subscribing users;

FIG. 9 illustrates suggested changes of a workflow accepted by a subscribing user;

FIGS. 10(a) and 10(b) illustrates example meta-data driven reports generated by the disclosed system; and

FIG. 11 illustrates an example meta-data driven reports generated by the disclosed system.

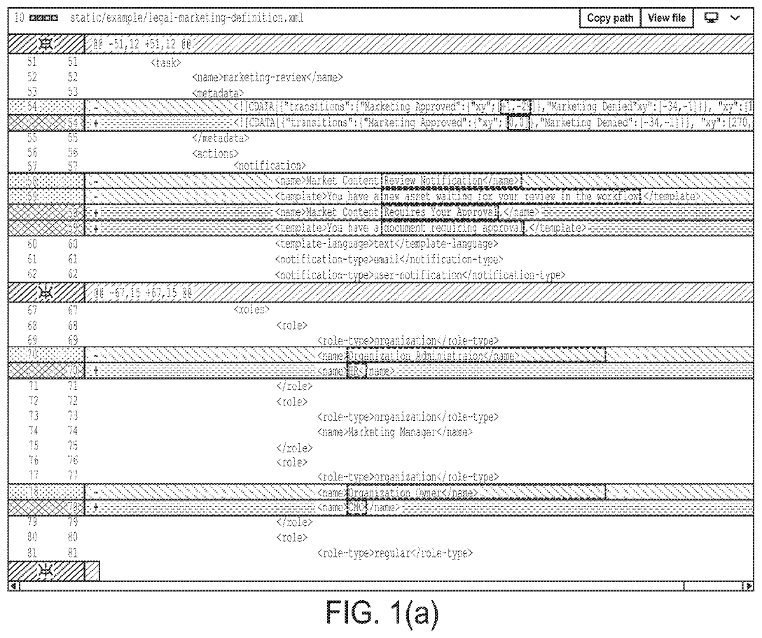

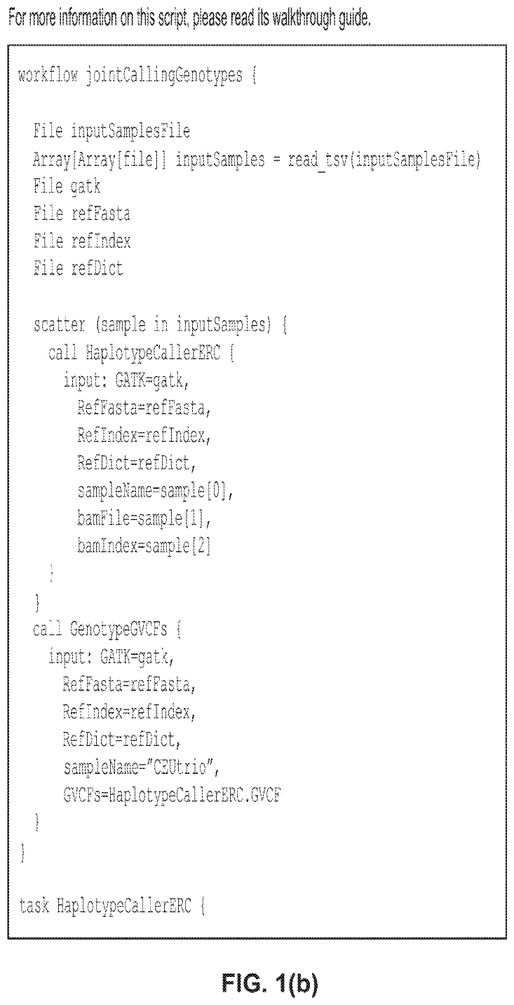

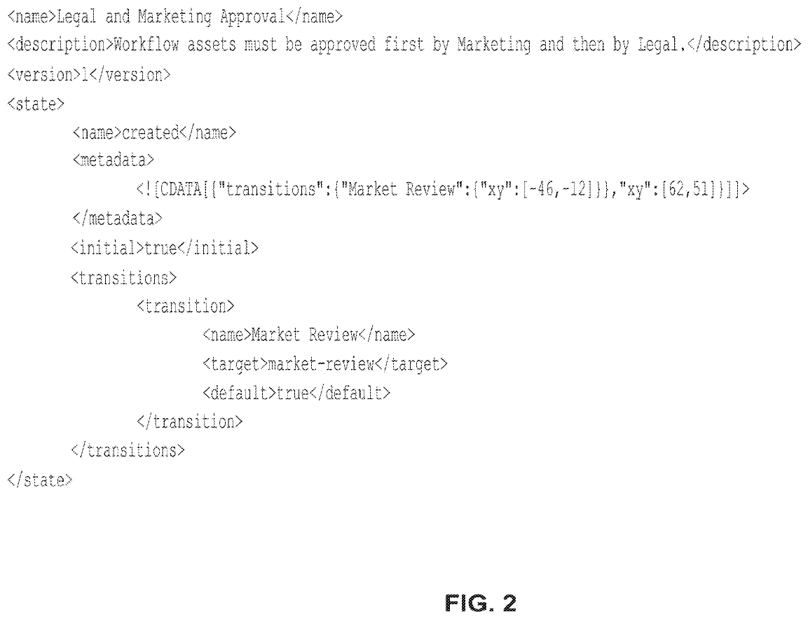

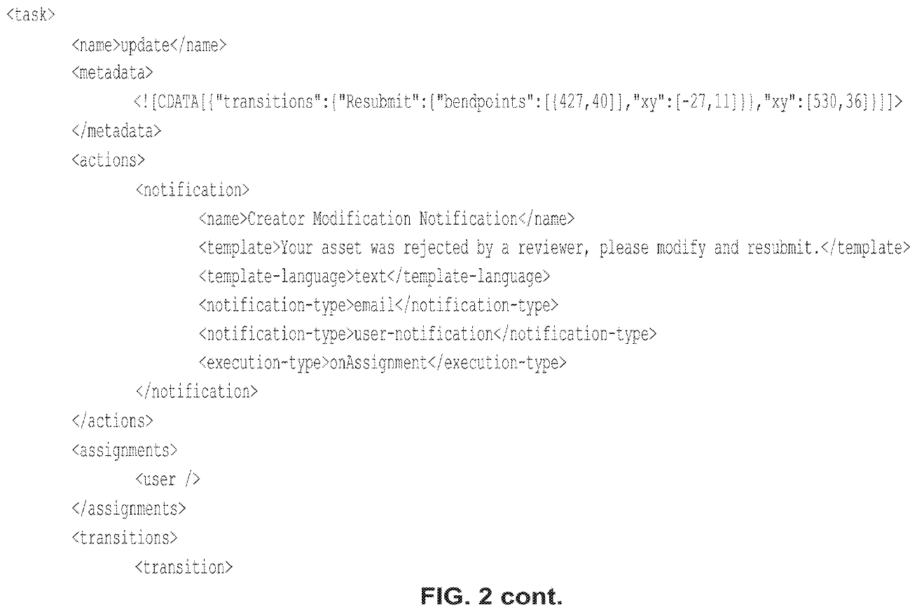

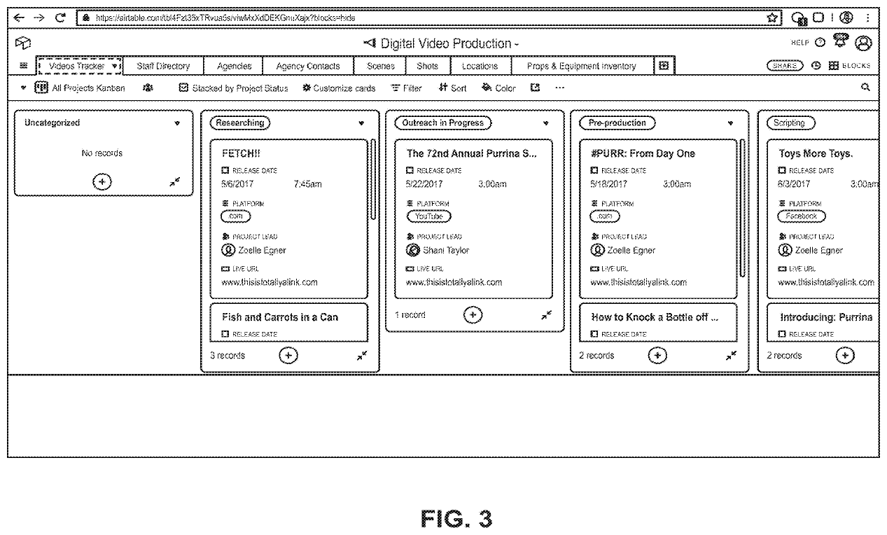

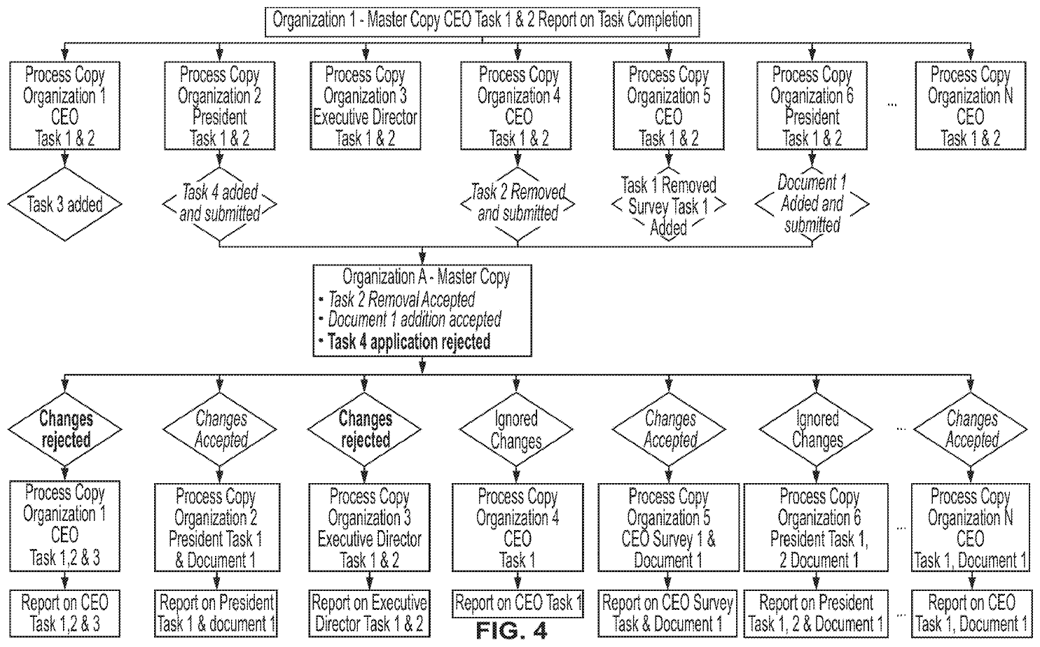

### DETAILED DESCRIPTION

A preferred embodiment of the invention is described below. It should be noted that this and any other embodiments described below are exemplary and are intended to be simple and illustrative of the invention rather than limiting.

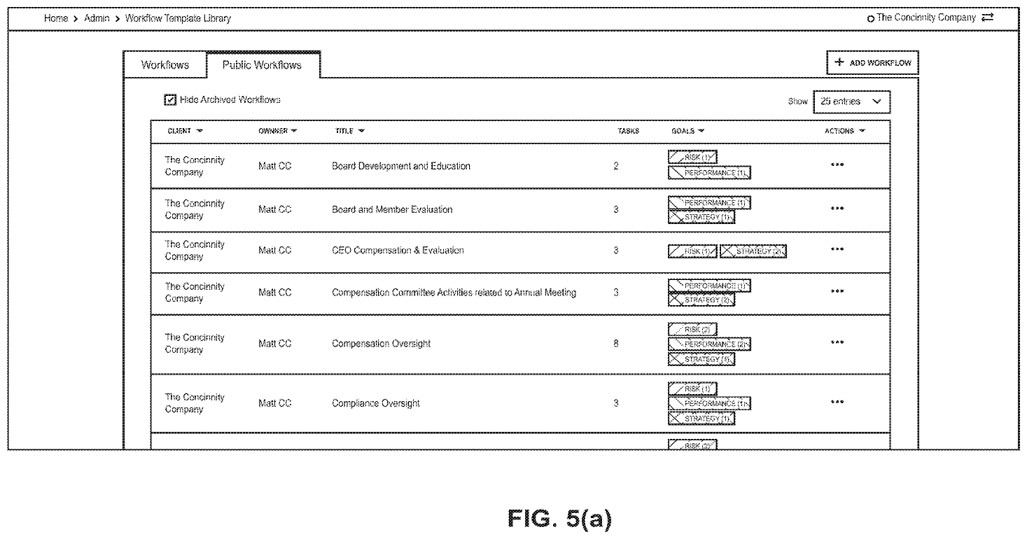

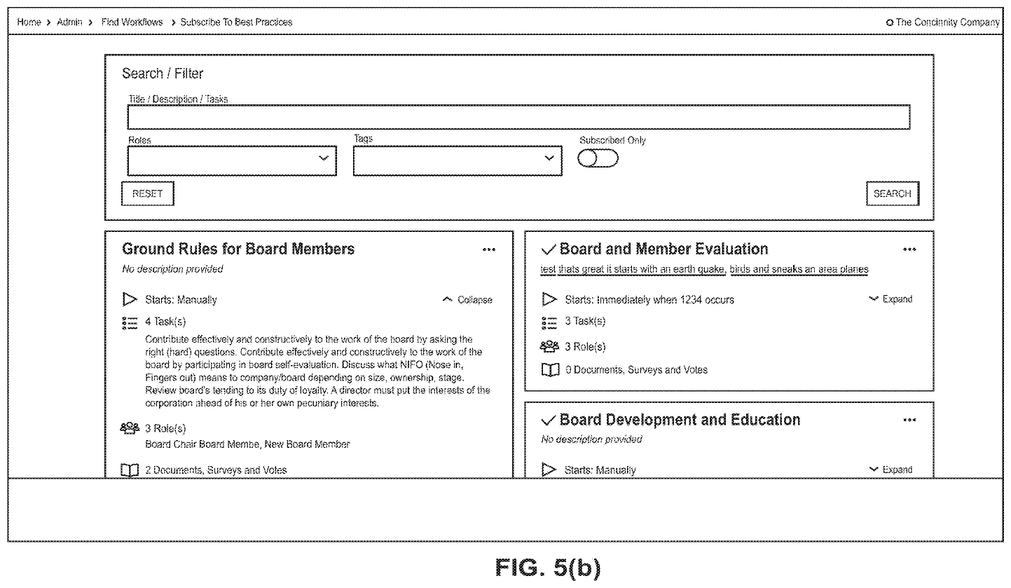

There are any number of business process designing platforms. According to aspects of the present disclosure, a user may create a multi-step business process and these processes may be saved to a library. FIGS. 5(a) and 5(b) respectively illustrate an example process library. From that library users are generally able to edit a process or start a process, i.e., assign tasks to individuals or systems, which upon completion of those tasks subsequent tasks follow along the defined business process.

In one aspect, the present disclosure discloses subscribing by e.g. a participating organization to a process from another source and continually submitting and receiving updates to that workflow as well as report on that process' goals. As will be described fully below, the present disclosure discloses implementing a system and method for comparing aspects of library version of business processes with a subscribing organization's meta-data. Further, the present disclosure discloses providing a system and method for an information flow by which participating organizations can exchange improvements and innovate together while maintaining their independence. In the meantime, these participating organizations may maintain the surrounding process for communicating, understanding and broadcasting those changes, including a dispute resolution methodology to assist the organization in customizing processes. In addition, the present disclosure discloses providing a system and method for generating data and reporting that execution data based on the subscribing organization's meta-data.

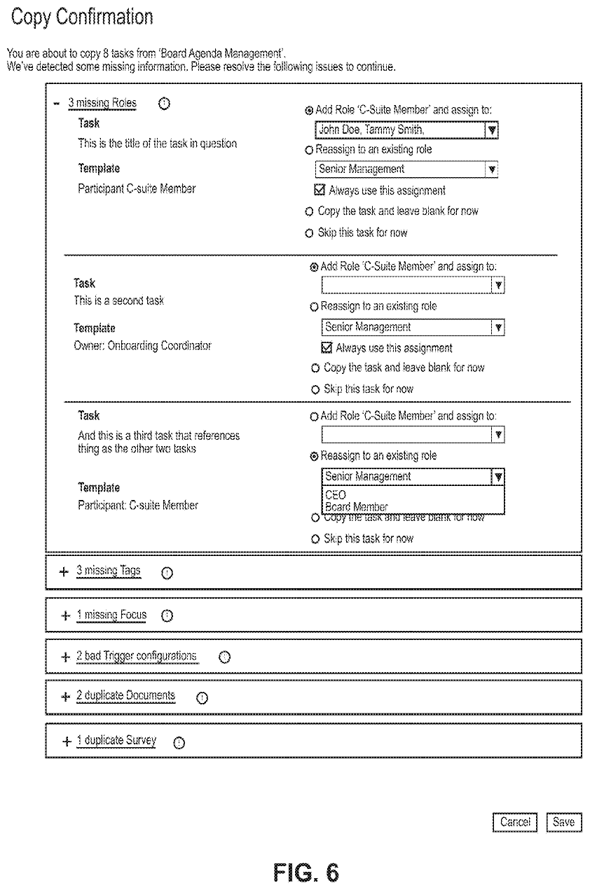

Initially, when a user subscribes to a process in the disclosed system, the system may be configured to determine existing mappings between two organizations and apply those mappings. Examples of the data the system determines to map include, but are not limited to, organizational roles, organizational role hierarchy, users within those roles, documents, votes, and surveys. Where the system cannot locate a mapping, the system may be configured to guide the user through creating an on the fly re-usable mapping. FIG. 6 illustrates an example copying or merging meta-data of subscribing organizations, according to an embodiment of the present disclosure. More specifically, one organization (org A) may be run by a CEO while another (org B) is run by an Executive Director. Whenever the two organizations share a business process, org A should reference the CEO while org B should reference the Executive Director, even sharing modifications to the process in subsequent changes. For example, if org A supplies additional CEO tasks to the process as project progresses, org B may be prompted to add those tasks for its Executive Director. The disclosed system may be configured to monitor or track all meta-data mappings, such that the business process can be displayed to each organization in the terminology that it perceives is “correct.” Once a subsequent organization subscribes to a workflow and puts in place its meta-data mappings, that organization can independently modify that workflow and continue using it as it sees fit.

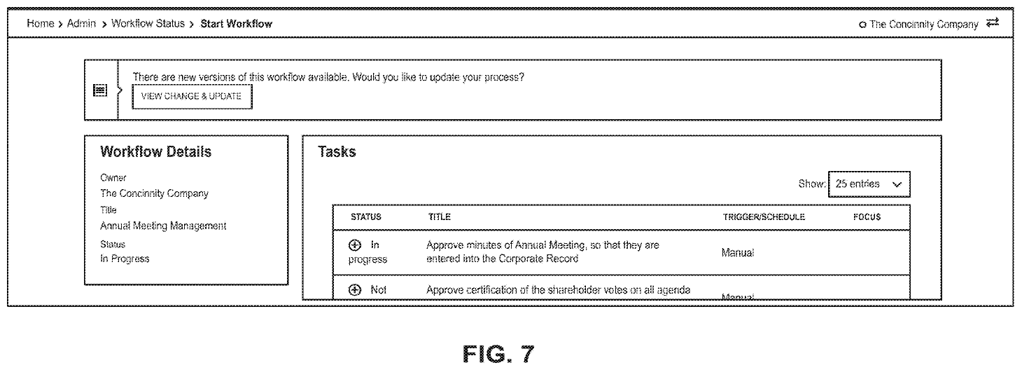

In accordance with additional aspects of the present disclosure, a system and method for an information flow may be contemplated such that all participating organizations can exchange improvements and innovate together while maintaining their independence. For example, if org A decided to supply additional tasks, modify existing tasks, or remove tasks, org B may be configured to access that information and accept or reject those changes. Referring to FIG. 7, a message may be generated by the disclosed system to prompt a user to update an existing workflow upon detecting new versions of the workflow are available. If org B modifies its task to be completed by another role, org B's version of the process should proceed with changes as desired. Optionally, org B may be configured to submit changes back to Org A, and those changes may be adopted and translated back into the meta-data definitions of org A.

The disclosed system may be configured to continually detect if qualitative changes have been made between a source process and the subscribing copy of the process, and track against the original mappings and not the actual data. For example, if a task has been assigned to the CEO of org A, John Smith, and the Executive director of org B, Jane Johnson, the system may be configured to use the roles of each company's users and meta-data mappings to determine that the tasks have been unchanged. In response to detecting that org B reassigns the task to its CFO Dana March, the disclosed system may be configured to inquire org B if it would like to submit a change to org A suggesting the task be reassigned to the meta-data mapping of the CFO. If no mapping exists, the disclosed system may be configured to allow org A to provide a new mapping on the fly.

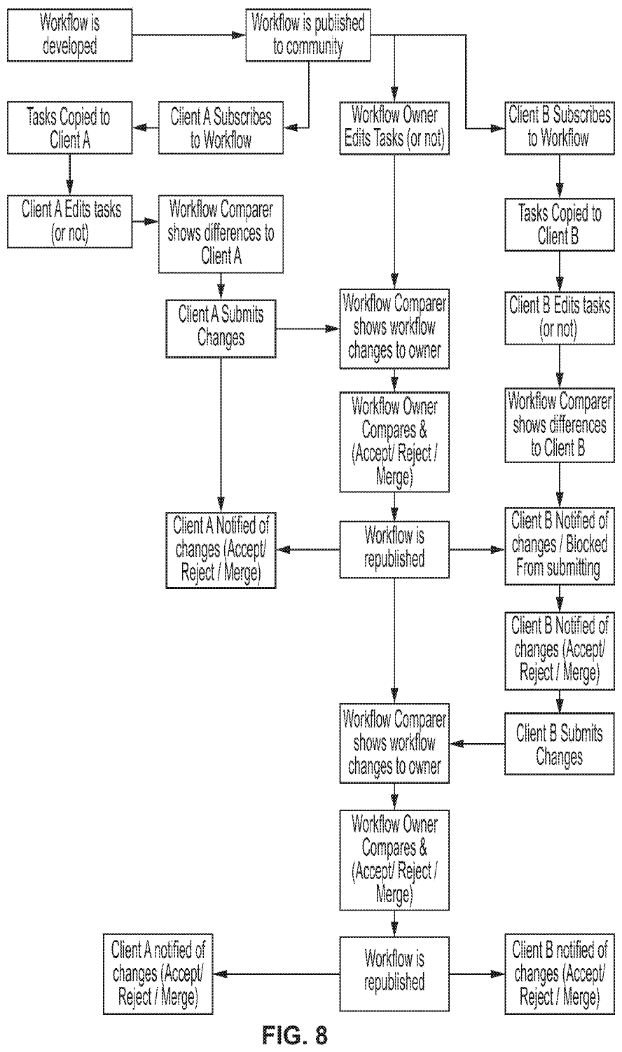

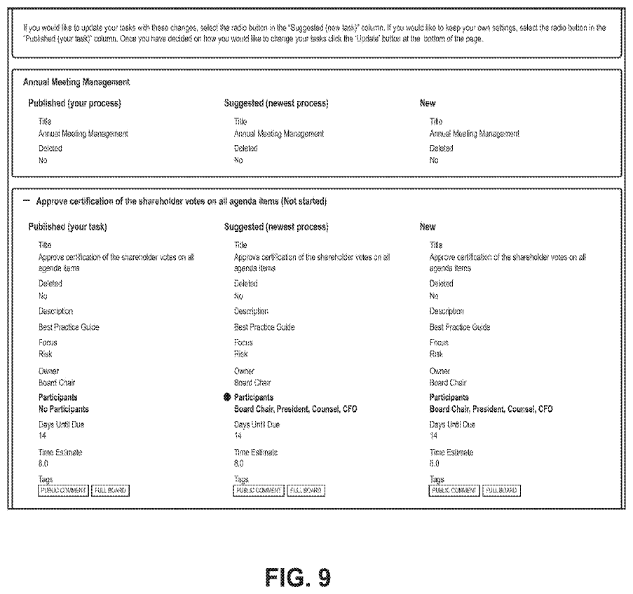

The system puts in place a data flow to allow multiple organizations to work with the same processes and for each organization to manage independently its changes. Referring to FIG. 8, a workflow may be developed and published to a community including multiple subscribing users. Once a subscribing user submits its changes to the owner of the original process, the owner of the workflow may be prompted to merge in the changes (or reject the changes) on a feature by feature basis. Meta-data mappings may be used to localize the language to the current organization. Referring to FIG. 9, the disclosed system may be configured to show the details of a published task by a user, determine or suggest a new task based at least on the details of the published task and meta-data mappings among subscribing users, and inquire the user about acceptance of the suggested new task. Upon detecting user acceptance of all the suggested changes, the disclosed system may be configured to update the workflow accordingly.

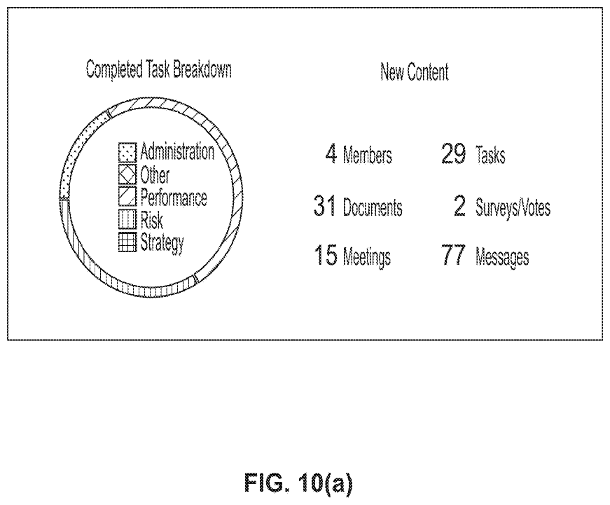

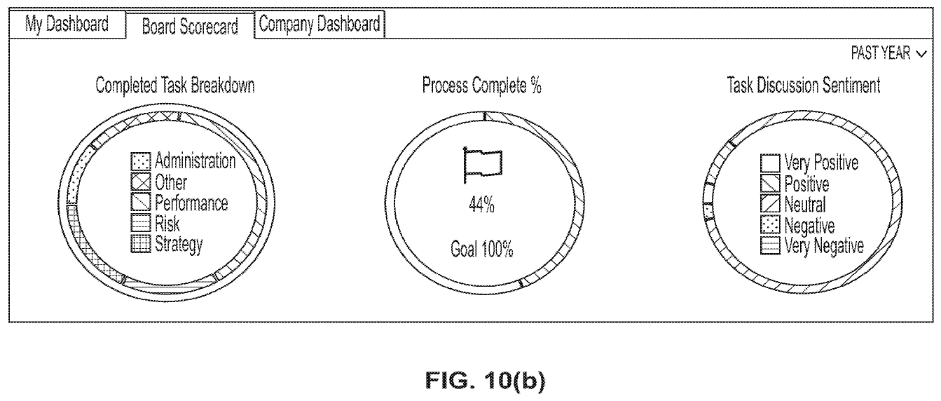

According to additional aspects, the present disclosure discloses generating execution data and reporting the execution data based on subscribing entity's meta-data. Once the process has been completed within an organization, the disclosed system can use the predefined reporting criteria (for instance a “goal”, “focus”, or “tag” associated with the source task) to automatically generate reporting information for each subscribing entity based on the process' defined reporting criteria. Aforementioned meta-data mapping may be used to alter reports on the fly to conform to each organization's needs. For example, org A may have a “compliance” tag associated with each task relating to legal compliance, while org B may focus its efforts on “risk management.” The disclosed system may be configured to provide mapping to generate different reports for each of the two organizations of the same source process. Referring to FIGS. 10(a) and 10(b), example meta-data driven reports generated by the disclosed system are illustrated.

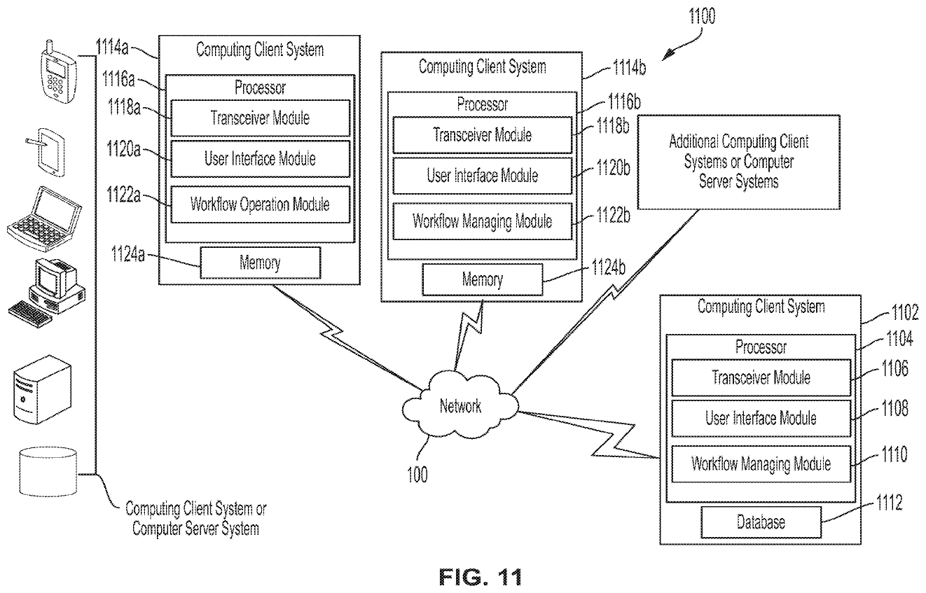

FIG. 11 illustrates an example architecture of the disclosed business process management system 1100, according to aspects of the present disclosure. For example, system 1100 may be deployed within a communication network environment 100 including a plurality of computing server system 1102 and computing client system 1114a, 1114b . . . . Each computing system may be on the same computer or separate computers. It is not necessary that each computing system is of the same operating system (OS) or central processing unit (CPU), type. In one embodiment, computing server system 1102 may include at least one controller or CPU or processor 1104, at least one transceiver module 1106 for exchanging information with other devices, at least one user interface module 1108, at least one workflow managing module 1110 for performing all workflow management functions described above, and one or more databases such as database 1112.

The term “module” as used herein refers to a real-world device, component, or arrangement of components implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module can also be implemented as a combination of the two, with certain functions facilitated by hardware alone, and other functions facilitated by a combination of hardware and software. In certain implementations, at least a portion, and in some cases, all, of a module can be executed on the processor of a general purpose computer. Accordingly, each module can be realized in a variety of suitable configurations, and should not be limited to any example implementation exemplified herein. Modules of computing server system 1102 may be controlled and executed by processor 1104 to facilitate all operations of the server 1102. The server 1102 may be configured in many different ways. For example, server 1102 may be a conventional standalone server computer or alternatively, the function of server 1102 may be distributed across multiple computing systems and architectures.

Processor of each computing server or client system may include one or more microprocessors and one or more supplementary co-processors. Each processor may be in communication with a corresponding data storage device via a communication medium, such as a USB port, serial port cable, a coaxial cable, an Ethernet type cable, a telephone line, a radio frequency transceiver or other similar wireless or wired medium or combination of the foregoing.

Each data storage device 1112, 1124a, 1124 may store, for example, a program (e.g., computer program code and/or a computer program product) adapted to direct a processor in accordance with the present invention. The program may be stored, for example, in a compressed, an uncompiled and/or an encrypted format, and may include computer program code. The instructions of the program may be read into a main memory of the processor from a computer-readable medium other than the data storage device, such as from a ROM or from a RAM. While execution of sequences of instructions in the program causes the processor to perform the process steps described herein, hard-wired circuitry may be used in place of, or in combination with, software instructions for implementation of the processes of the present invention. Thus, embodiments of the present invention are not limited to any specific combination of hardware and software.

Server 1102 of the present disclosure may interact and/or control one or more computing client systems 1114a, 1114b or any terminals deployed within the communication network 100. The server/client device or terminal may include any one or a combination of at least one of personal computers, servers, laptops, tablets, mobile devices, smart phones, cellular devices, portable gaming devices, media players, network enabled printers, routers, wireless access points, network appliances, storage systems, gateway devices, or any other suitable devices that may have been deployed in the same or different networks. In one embodiment, computing server system 1102 may be one of the computing client systems 1114a, 1114b . . . .

It is to be appreciated that the system 1100 may include any suitable and/or necessary interface components (not shown), which provide various adapters, connectors, channels, communication paths, to facilitate exchanging signals and data between various hardware and software components of each computing client system 1114a, 1114b . . . and any applications, peer devices, remote or local server systems/service providers, additional database system(s), and/or with one another that are available on or connected via underlying network connections and associated communication channels and protocols (e.g., Internet, wireless, LAN, cellular, Wi-Fi, WAN).

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In the interest of clarity, not all of the routine features of the aspects are disclosed herein. It will be appreciated that in the development of any actual implementation of the present disclosure, numerous implementation-specific decisions must be made in order to achieve the developer's specific goals, and that these specific goals will vary for different implementations and different developers. It will be appreciated that such a development effort might be complex and time-consuming, but would nevertheless be a routine undertaking of engineering for those of ordinary skill in the art having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method, comprising:
determining, by at least one processor of a computing device, a workflow for multiple business organizations to share within a communication network;
subscribing to the workflow by each of the multiple business organizations via at least providing various information and data related to each business organization;
receiving, by the at least one processor, the various information and data related to each business organization;
determining, by the at least one processor, mapping relationships for the various information and data related to each business organization;
operating the workflow by each of the multiple business organizations independently;
instantaneously tracking, by the at least one processor, any modifications made by each of the multiple business organizations with respect to the workflow; and
merging, by the at least one processor, any selected modifications made by the multiple business organizations into the workflow and republishing the workflow to the multiple business organizations via the communication network.

2. The method of claim 1, wherein the various information and data related to each business organization comprise at least one of: organizational roles, an organizational role hierarchy, users within the organizational roles, documents, votes, tags, forms, and surveys.

3. The method of claim 1, further comprising:
receiving, by the at least one processor, meta-data related to at least one modification made by each of the multiple business organizations with respect to the workflow.

4. The method of claim 1, wherein operating the workflow by each of the multiple business organizations independently comprises:
determining one or more tasks for each organizational role within each of the multiple business organizations; and
modifying existing tasks for each organizational role within each of the multiple business organizations.

5. The method of claim 1, further comprising rejecting, by the at least one processor, one or more modifications made by one of the multiple business organizations.

6. The method of claim 4, further comprising generating, by the at least one processor, database and user interface, reporting information for each of the multiple business organizations.

7. The method of claim 4, wherein the instantaneously tracking, by the processor, any modifications made by each of the multiple business organizations with respect to the workflow comprises:
detecting a modification of an existing task for an organization role within one of the multiple business organizations;
determining tasks affected by the modification within remaining business organizations based on the mapping relationships; and
generating and transmitting notifications of the modification to the remaining business organizations.

8. The method of claim 7, wherein each of the remaining business organizations is configured to modify a corresponding task affected by the modification.

9. The method of claim 7, wherein each of the remaining business organizations is configured to reject the modification in a corresponding task affected by the modification.

10. The method of claim 1, further comprising:
determining, by the at least one processor, no mapping relationship among at least a portion of the various information and data related to each business organization; and
generating a mapping relationship on the fly for at least the portion of the various information and data related to each business organization.

11. A system including a plurality of computing devices deployed within a communication network, the system comprising:
a first computing device configured to determine a workflow for multiple business organizations to share within a communication network; and
one or more second computing devices associated with the multiple business organizations configured to subscribe to the workflow by at least providing various information and data related to each business organization;
wherein the first computing device is configured to receive the various information and data related to each business organization, determine mapping relationships for the various information and data related to each business organization,
wherein each second computing device is configured to operate the workflow within each business organization independently;
wherein the first computing device is configured to instantaneously track any modifications made by each of the multiple business organizations with respect to the workflow, merge any selected modifications made by the multiple business organizations into the workflow, and republish the workflow to the multiple business organizations via the communication network.

12. The system of claim 11, wherein the various information and data related to each business organization comprise at least one of: organizational roles, an organizational role hierarchy, users within the organizational roles, documents, votes, tags, forms, and surveys.

13. The system of claim 11, wherein the first computing device is further configured to receive meta-data related to at least one modification made by each of the multiple business organizations with respect to the workflow.

14. The system of claim 11, wherein each second computing device is configured to operate the workflow within each business organizations independently at least by:
determining one or more tasks for each organizational role within each of the multiple business organizations; and
modifying existing tasks for each organizational role within each of the multiple business organizations.

15. The system of claim 11, wherein the first computing device is further configured to reject one or more modifications made by one of the multiple business organizations.

16. The system of claim 14, wherein the first computing device is further configured to generate reporting information for each of the multiple business organizations.

17. The system of claim 14, wherein the first computing device instantaneously tracks any modifications made by each of the multiple business organizations with respect to the workflow at least by:
detecting a modification of an existing task for an organization role within one of the multiple business organizations;
determining tasks affected by the modification within remaining business organizations based on the mapping relationships; and
generating and transmitting notifications of the modification to the remaining business organizations.

18. The system of claim 17, wherein each of the remaining business organizations is configured to modify a corresponding task affected by the modification.

19. The system of claim 17, wherein each of the remaining business organizations is configured to reject the modification in a corresponding task affected by the modification.

20. The system of claim 11, wherein the first computing device is further configured to determine no mapping relationship among at least a portion of the various information and data related to each business organization, and generate a mapping relationship on the fly for at least the portion of the various information and data related to each business organization.
